(19) United States
(12) Patent Application Publication
(10) Pub. No.: US 2014/0369669 A1
(43) Pub. Date: Dec. 18, 2014

(54) ELECTRONIC DEVICE AND VALUE EXCHANGE METHOD

(71) Applicants: Kabushiki Kaisha Toshiba, Tokyo (JP); Toshiba Lifestyle Products & Services Corporation, Tokyo (JP)

(72) Inventors: Yuki Kaneko, Kawasaki (JP); Hideo Kezuka, Tokyo (JP); Hideyuki Toma, Tokyo (JP)

(21) Appl. No.: 14/471,629

(22) Filed: Aug. 28, 2014

Related U.S. Application Data
(63) Continuation of application No. PCT/JP2013/059110, filed on Mar. 27, 2013.

(51) Int. Cl. H04N 5/85; G11B 27/02

(52) U.S. Cl. CPC H04N 5/85; G11B 27/02
USPC 386/248

(57) ABSTRACT

According to one embodiment, a value exchange method for use in a data management device which connects with a data supply source via a network including, calculating a first value corresponding to information which is received from the data supply source and includes metadata extracted with a specific condition with respect to a video program and a second value corresponding to information which is supplied to the data supply source and includes history information associated with a result of viewing or recording of a video program identified by the metadata based on a prescribed value determination condition, and determining a difference between the first value and the second value as an exchange value.

### CROSS-REFERENCE TO RELATED APPLICATIONS

This application is a Continuation Application of PCT Application No. PCT/JP2013/059110, filed Mar. 27, 2013, the entire contents of which are incorporated herein by reference.

### FIELD

Embodiments described herein relate generally to an electronic device and a value exchange method.

### BACKGROUND

Electronic devices which receive and store programs supplied by broadcasters and distributors and reproduce them in response to a user's request, for example, a recorder device (hereinafter, referred to as a client terminal or a user) which connects with a television reception device or a monitor (display) device, are capable of receiving (acquiring) and transmitting (supplying) various kinds of information via a network such as the Internet.

Information supplied (transmitted) by the user (client terminal) is often, for example, the user's taste and an access history using the Internet, etc., which are associated with video reproduced (recorded) by the user, etc. Information acquired (received) by the user is often, for example, a broadcast schedule (program table) of a program to the user's taste and information on a site on the Internet, etc.

The above-described supply of information (metadata) to the user and acquisition of information (taste, history) from the user in a network are managed by a metadata creation mechanism (data supply source).

Thus, reception or exchange of values is necessary between the user and the data supply source.

However, a method of exchanging (receiving) values between the user and the data supply source is not clearly specified at present. Delivery (supply and acquisition) of information between the metadata supply source and the user is often carried out by way of, for example, a social networking service (SNS) mechanism, a (taste information) database holding mechanism (management company) holding taste information of the user, etc., and the user does not need to be conscious of direct delivery of information to and from the metadata supply source.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1 shows an example of an outline of a system configuration according to an embodiment;

FIG. 2 shows an example of an outline of a system configuration according to an embodiment;

FIG. 3A shows an example of information supplied by a data supply source in a system according to an embodiment;

FIG. 3B shows an example of information supplied by the data supply source in a system according to an embodiment;

FIG. 3C shows an example of information supplied by the data supply source in a system according to an embodiment;

FIG. 3D shows an example of information supplied by the data supply source in a system according to an embodiment;

FIG. 4 shows an example of an operation of a transmitter (source) and a receiver (sink) according to an embodiment;

FIG. 5A shows an example of information supplied by the data supply source in a system according to an embodiment; and

FIG. 5B shows an example of information supplied by the data supply source in a system according to an embodiment.

### DETAILED DESCRIPTION

Various embodiments will be described hereinafter with reference to the accompanying drawings.

In general, according to one embodiment, a value exchange method for use in a data management device which connects with a data supply source via a network comprising: calculating a first value corresponding to information which is received from the data supply source and includes metadata extracted with a specific condition with respect to a video program and a second value corresponding to information which is supplied to the data supply source and includes history information associated with a result of viewing or recording of a video program identified by the metadata based on a prescribed value determination condition, and determining a difference between the first value and the second value as an exchange value.

Embodiments will now be described hereinafter in detail with reference to the accompanying drawings.

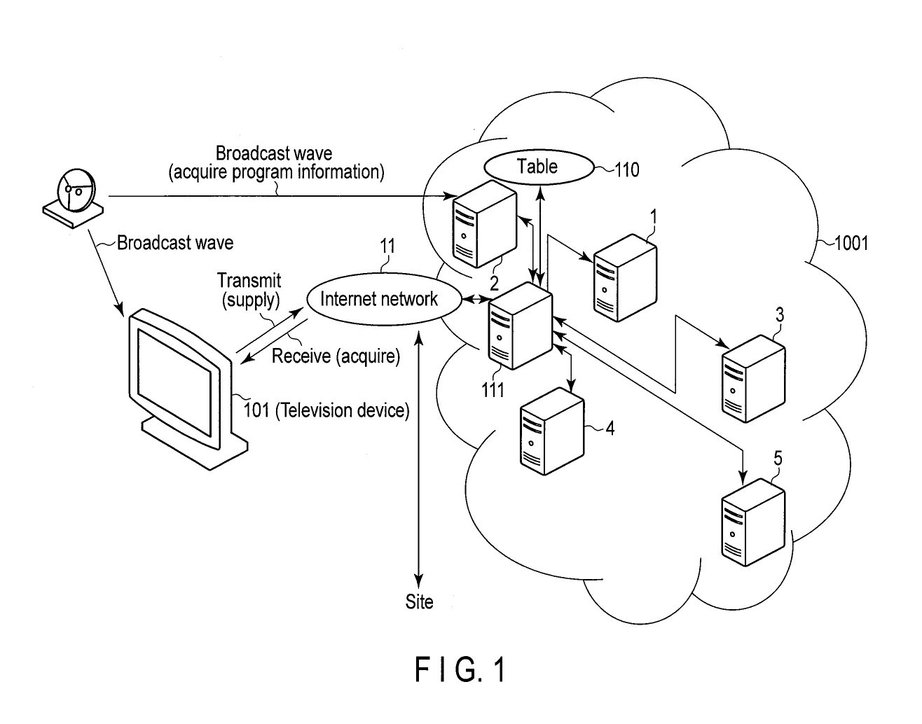

FIG. 1 shows an outline of connection between: an electronic apparatus 101 which is a user (client terminal); a network which connects with the electronic apparatus 101, for example, an Internet network 11; and at least one server or servers (external service mechanism) 1, . . ., N (N is a positive integer) located on the Internet network 11.

The external service mechanism (server/servers) 1, . . N may be generically called, for example, a cloud service (1001).

The electronic apparatus 101 will be described taking a digital television broadcast reception device (hereinafter, referred to as a television device) capable of receiving and reproducing (and recording) a digital broadcast (program) as an example. The television device 101 includes a combination of a monitor (display) device and a recorder device connected therewith, etc. Although FIG. 1 discloses only one set of the television device 101, the number of television devices 101 is arbitrary, for example, several tens of thousands to several million. The electronic apparatus 101 may be any device which is equipped with, for example, a user interface, a communication function, a function of receiving a broadcast, a processing function of processing a received broadcast, i.e., a program, a program output function of outputting a program, a storage function or the like. An example of the device is a digital recorder, etc. The electronic apparatus 101 can be applied as a personal computer (PC) having a function of receiving a broadcast, a video display device (monitor device) connecting with a video storage device, etc., comprising a broadcast reception device, a portable terminal device having a broadcast reception function, or the like. A broadcast includes those supplied by a broadcaster (broadcast station) as radio waves propagated in space, those distributed by a distributor through a network such as a cable and an Internet Protocol (IP) network, or the like. In addition, the broadcast includes video, audio and/or music, etc., and supplies a program in units of a specific time (broadcast time) successively or for a specific period (time). A program may also be called content or a stream. Video includes a motion picture, a still picture or a text (information represented by a character or a sign, etc., indicated by a coded code string), and an arbitrary combination of these.

The external service mechanism 1, . . N include, for example, a history (taste information) server 1, an EPG server (database) 2, a calendar/channel data server (database) 3, an automatic recording recommendation server 4, a data supply source (metadata) server 5, etc. The history server 1 and the automatic recording recommendation server 4 (or the EPG server 2) are often run by, for example, manufacturers (makers) of the television device 101 or entrusted companies. On the other hand, the data supply source (metadata) server 5 is generally prepared and managed (run) by a metadata creation mechanism (metadata creation company). The EPG server 2 or the calendar/channel data server 3 may be prepared and managed (run) by an independent enterprise.

The history (taste information) server 1 holds the user's taste, for example, information on a program the user has viewed or recorded (reproduced), i.e., a history (log data), etc. The history server 1 also acquires an access history of a site accessed by the television device 101, information on settlement of merchandise purchased in an accessed site/purchase of a ticket for a concert, etc./accommodation arrangements, and the like.

The EPG server 2 acquires information on a program received by the television device (user) 101 independently of (direct) reception by television device 101, and holds it as a database (DB).

The calendar/channel data server (database) 3 holds a broadcasting date and time of a program for which the user has made a recording reservation, a name of a broadcast station (channel) in an area where the user can receive (view/record) and a name of a channel supplied by distributors, a broadcasting schedule of other stations whose broadcasting time overlaps partly with that of a program for which the user has made a recording reservation, rebroadcast information (including a program for which the user has made a recording reservation), and the like.

The automatic recording recommendation server 4 extracts and holds a program which is viewed by the user and held by the history server 1 or a program associated with a program for which the user has made a recording reservation, in order to recommend the user to view or record a program conforming to the user's taste.

The data supply source (metadata) server 5 holds data which is prepared and managed by the metadata creation mechanism (metadata creation company) that handles various kinds of information related to broadcast, i.e., metadata.

Delivery of data between the television device 101 and the history server 1, i.e., supply (transmission) of information from the television device 101 to the history server 1 and acquisition (reception) of information by the television device 101 from the history server 1, are handled by a data controller (control device) 111.

The data controller 111 connects with a table (rewritable data holder) 110. The table 110 holds the rules concerning reception of values between the data supply source server 5 and the user for acquisition of information (taste, history) by the data supply source server (data supply source) 5 from the user (television device) 101 and supply of information (metadata) from the data supply source server 5 to the user, for example, a program (computation expression), a reference table or the like for computing a value making a comparison between a value of information supplied acquired by the user and a value of information supplied to the data supply source server 5.

The data controller 111 also handles delivery of data between the external service mechanisms 1, . . ., N, i.e., between the history server 1, the EPG server 2, the calendar/channel data server 3, the automatic recording recommendation server 4 and the data supply source (metadata) server 5. The data controller 111 also handles recommendation processing of receiving a recommendation from the user and processing it as taste information (has a function as a recommendation processing engine [RE]).

In addition, the data controller 111 controls connection and data delivery between an arbitrary site (Web page) located on the Internet network 11, and the electronic device (user) 101.

As shown in FIG. 1, the television device 101 connects with an arbitrary server (external service mechanism) 1, . . ., N on the Internet network 11 through the data controller 111. The data controller 111 may be located in the television device 101 (the data controller 111 may be united with the television device 101).

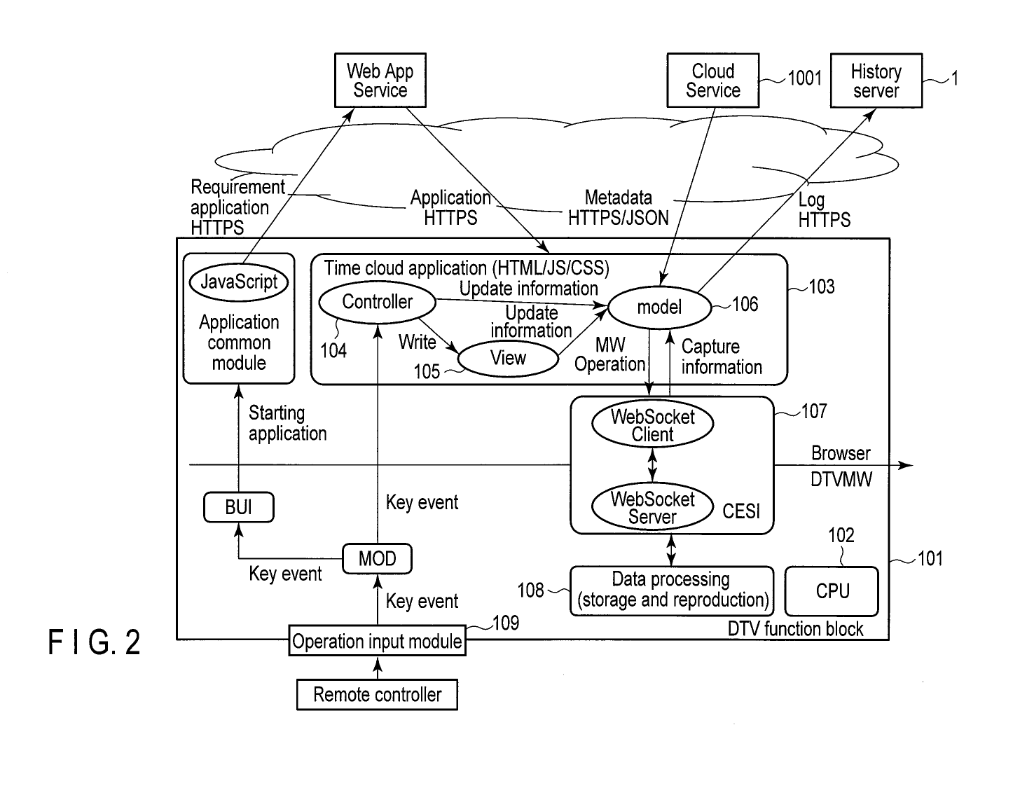

For access to and from the data controller 111, the television device 101 holds, for example, a cloud application (HTML/JS/CSS) whose example is shown in FIG. 2, as firmware of a CPU (processor) 102 included in the television device 101 or as an (external application) acquired operatively by the CPU 102.

FIG. 2 shows an outline of the cloud application (HTML/JS/CSS).

The cloud application (HTML/JS/CSS) 103 includes, for example, a “Controller” 104 carrying out key event (core) processing, a “View” 105 carrying out screen display, a “model” 106 carrying out information acquisition from an arbitrary server (external service mechanism) 1, . . N connected through DTVMW (path to and from a browser [the Internet network 11]) and the Internet network 11, and operation of the television device 101, etc. The television device 101 includes a cloud module (CESI) 107 performing data delivery (transmission of taste information and a viewing/recording reservation, acquisition of automatic recording recommendation service information, access to facilities and distribution that have appeared in a program, etc.) between the history server 1, the EPG server 2 and the automatic recording recommendation server 4 through a network, a data processing (storage and reproduction) module 108 performing recording and reproduction of a program, search for a program and a scene/keyword (merchandise), etc., an operation input module (remote control reception module) 109 receiving input of an instruction by an operator, etc. The operation input module 109 may be, for example, a portable terminal device prepared with a predetermined application (software) to enable the operation of the television device 101 to be controlled, for example, a tablet device, a multifunctional communication terminal device (smartphone), etc.

The television device 101 transmits an IP address of the television device (itself), taste information, etc., to the automatic recording recommendation server 4 via the Internet network 11.

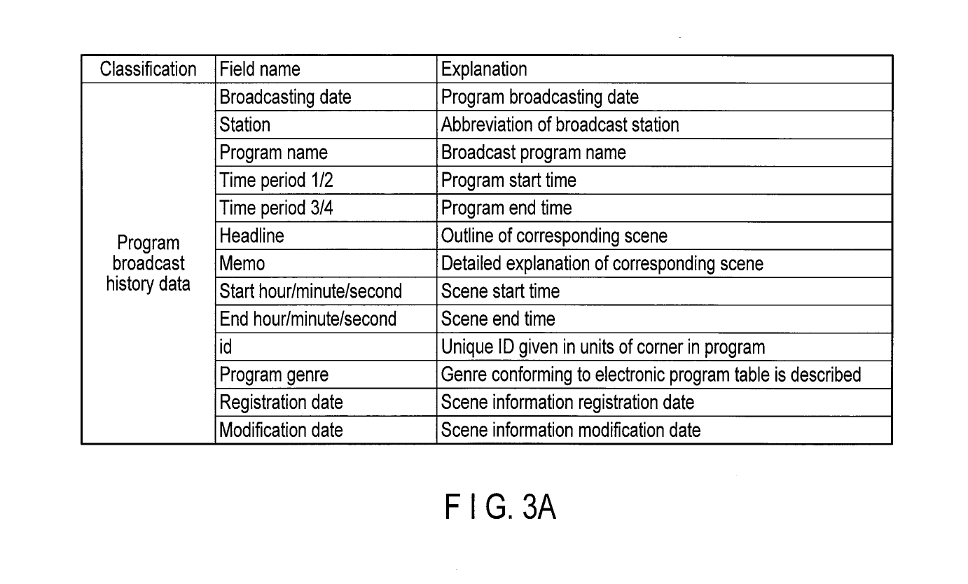

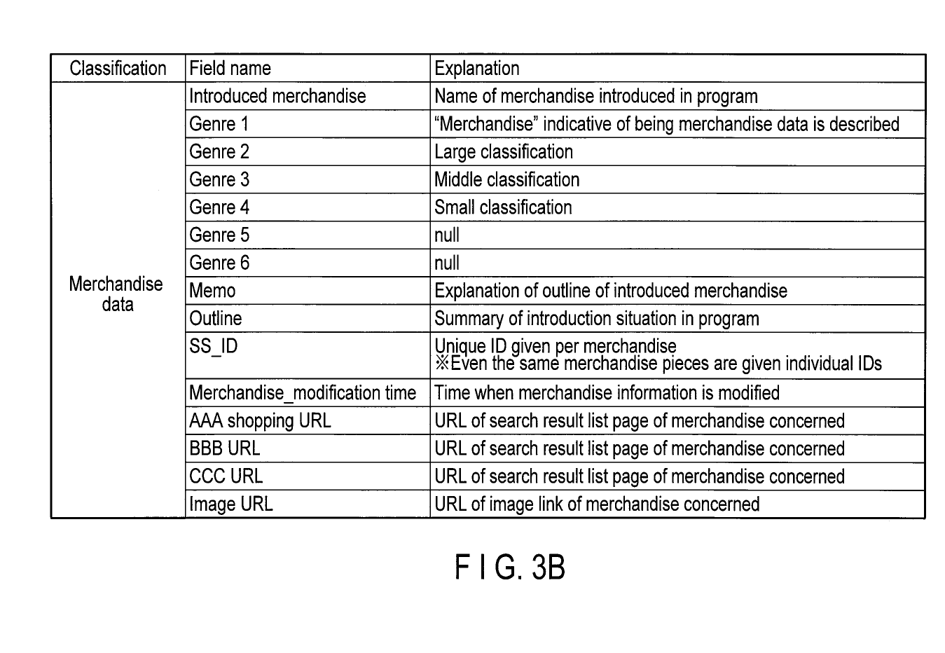

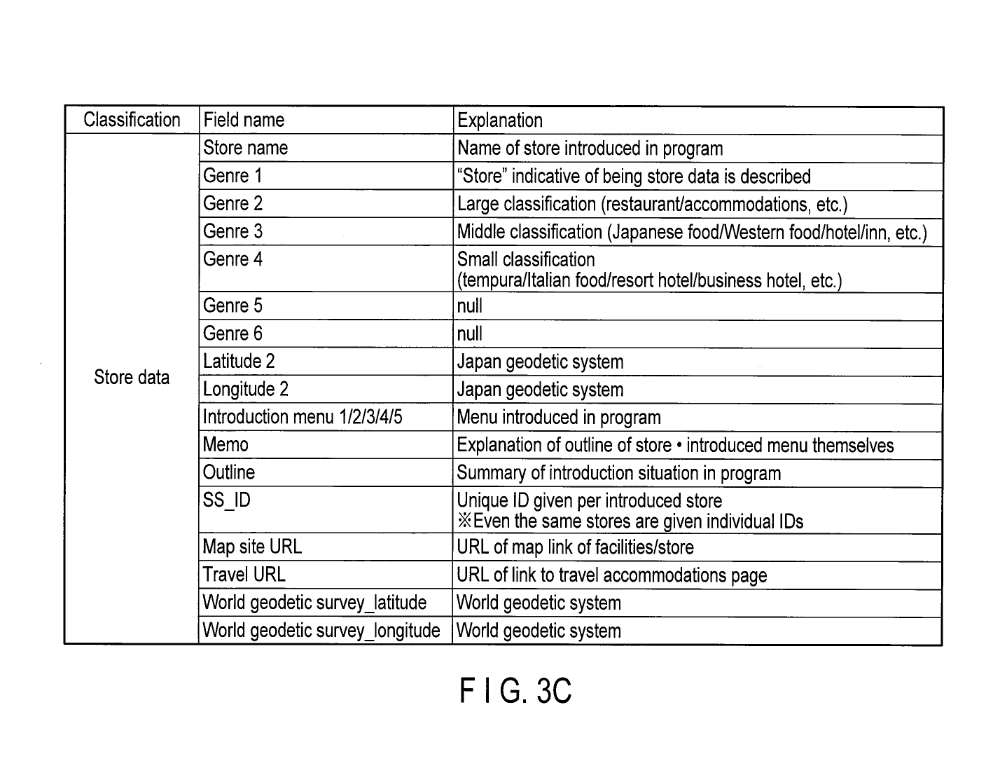

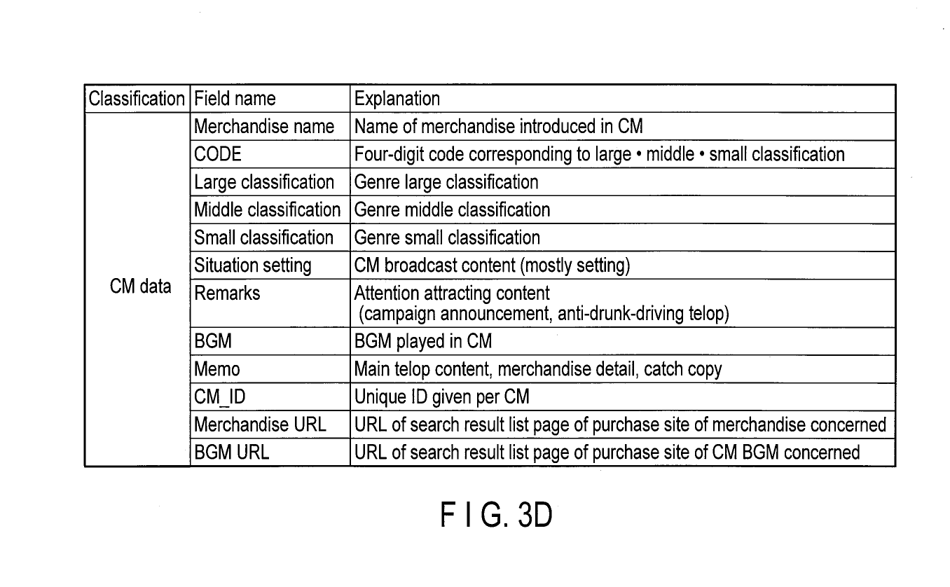

The automatic recording recommendation server 4 refers to a keyword input from the television device 101, program search information (date and time/channel) and user information (taste which can be estimated from a program recorded/reproduced previously) held by the history server 1, carries out matching with program information held by each of the EPG server 2, the calendar/channel data server 3 and the data supply source (metadata) server 5, i.e., extraction of an automatic recording recommendation program to the television device 101 (user), and supplies information on a matched program to the television device 101. Metadata held by the data supply source server 5 includes broadcast history data, merchandise data, store data, CM broadcast history data, etc., as shown in FIG. 3A, FIG. 3B, FIG. 3C and FIG. 3D.

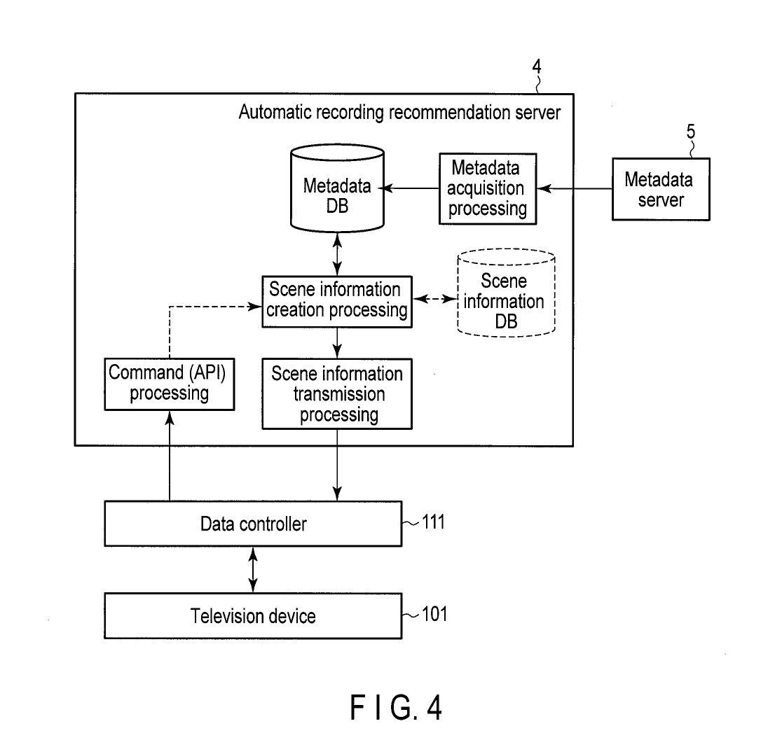

The automatic recording recommendation server 4, whose example is shown in FIG. 4, acquires metadata held by a metadata creation company, i.e., the data supply source (metadata) server 5, carries out the above extraction of an automatic recording recommendation program to the television device 101, and supplies information on a matched program to the television device 101. In extraction of a program, various kinds of information such as an arbitrary scene included in a program, for example, a specific performer, specific music, specific merchandise, etc., are used. The user's taste identified by recommendation processing is also reflected.

FIG. 4 shows an example of the structure of an automatic recording recommendation server according to the embodiment.

A function provided by the automatic recording recommendation server 4 will be described. In the following description, the data controller 111 intervenes at the time of data delivery between the television device (user/client terminal) 101 and the automatic recording recommendation server 4 or the metadata server 5. As stated above, the data controller 111 can store, in the history server 1, information supplied (transmitted) from the user (the television device 101) to the metadata server 5 and information supplied from the metadata server 5 to the user (received by the user).

### <Command (WebAPI) Processing>

The automatic recording recommendation server 4 acquires various kinds of data described below and supplies them to the television device 101. Various kinds of data include, for example, “scene information”, “automatic recording recommendation” program, etc.

### <Acquisition of a List of “Scene Information”

A list of “scene information” of a program matching a condition designated by the user (television device) 101 is acquired. If a plurality of lists of “scene information” matching a designated condition are present, all of them are acquired. If no list of “scene information” matching a condition is present, this fact is notified.

### <Acquisition of a “Table of Programs” Whose List of “Scene Information” is Present>

A “table of programs” in which a program whose list of “scene information” of a condition designated by the user (television device) 101 is present is listed is acquired.

### <Acquisition of “Scene Information” List Table>

A “scene information list table” which is a list of “scene information” registered in a program designated by the user (television device) 101 is acquired.

### <Acquisition of a Scene Information List (ID Designation)>

A list of “scene information” of a designated ID is acquired from “scene information list table”.

### <Search for “Scene Information”

A “scene information list” including “scene information” matching a designated search condition is acquired. An arbitrary keyword input by the user can be designated as a search condition.

### <Acquisition of Recommendation “Scene Information”

“Favorite scene information” registered by the user managed by the history server 1, a keyword (metadata) based on the user's taste, etc., are acquired.

### <Metadata Acquisition Processing>

Metadata supplied by the metadata server 5 is acquired.

In acquisition of metadata supplied by the metadata server 5, a WebAPI supplied by the metadata server 5 is used.

### “Scene Information” Creation/Transmission Processing>

“Scene information” is created based on metadata acquired from the metadata server 5, or is extracted as an automatic recording recommendation program and is transmitted to the television device 101.

Processing executed at the time of creating “scene information” is shown below.

### (A) Draw of Program Information

The television device 101 transmits:
(a) a program name (or identification information such as a program ID);
(b) a program broadcasting date and time; and
)c) a channel number.

The metadata server 5 searches a database in the metadata server 5 based on the above-described (a) a program name, (b) a program broadcasting date and time and (c) a channel number received from the television device 101. If a corresponding program whose one or more “scene information” item is registered is present, the metadata server 5 creates the one or more “scene information” item and then transmits it to the television device 101.

If a plurality of corresponding programs are present, the metadata server 5 transmits all candidates to the television device 101.

If no corresponding program is present, the metadata server 5 transmits this fact to the television device 101. That is, the television device 101 transmits identification information (a program name, a program broadcasting date, a channel number, etc.) of a program to the metadata server 5, and receives “scene information” corresponding to a scene in a program from the metadata server 5.

### (B) Search for “Scene Information”

The database in the metadata server 5 is searched for metadata information matching a search condition received from the television device 101, and a list of “scene information” including corresponding metadata information is transmitted to the television device 101. Metadata to be searched for is program broadcast history data, merchandise data, store data and CM broadcast history data shown in FIG. 3A, FIG. 3B, FIG. 3C and FIG. 3D.

### (C) Creation of Scene Information

Broadcast history data, merchandise data, store data and CM broadcast history data stored in the database in the metadata server 5 are associated, and “scene information” is created. Merchandise information and store information may not present in one “scene information” item. In addition, a plurality of merchandise data items and store data items may be associated in one “scene information” item.

### (D) Extraction of an Automatic Recording Recommendation Program

The automatic recording recommendation server 4 extracts a keyword received from the television device 101 or the history server 1 and the taste of the user (the television device 101) held by the history server 1 (program information of a program the user has viewed or a program for which the user has made a recording reservation, a “keyword” included in the program, or information registered by the user), and sets a search condition.

That is, the automatic recording recommendation server 4 searches the database in the metadata server 5 for metadata information matching a set search condition, and transmits a list of “program” including corresponding metadata information as an automatic recording recommendation list to the television device 101. At this time, if a recording (viewing) reservation has been set in the television device 101, recording (viewing) of a program for which the recording (viewing) reservation has been made is carried out first. Data held by the EPG server 2 and the calendar/channel data server 3 is referred to, and if there is rebroadcast of the same program, a date and time of the rebroadcast is sent to the television device 101 as an automatic recording recommendation program.

Thus, between the user (client/television device) 101, i.e., the data controller 111, and the metadata server (data supply source server) 5, there are acquisition of information (taste, history) by the metadata server 5 from the data controller 111 (the television device 101) and supply of information (metadata) from the metadata server 5 to the user, i.e., delivery of data. Accordingly, it is necessary to receive values between the metadata server 5 and the user (the data controller 111 [the television device 101]).

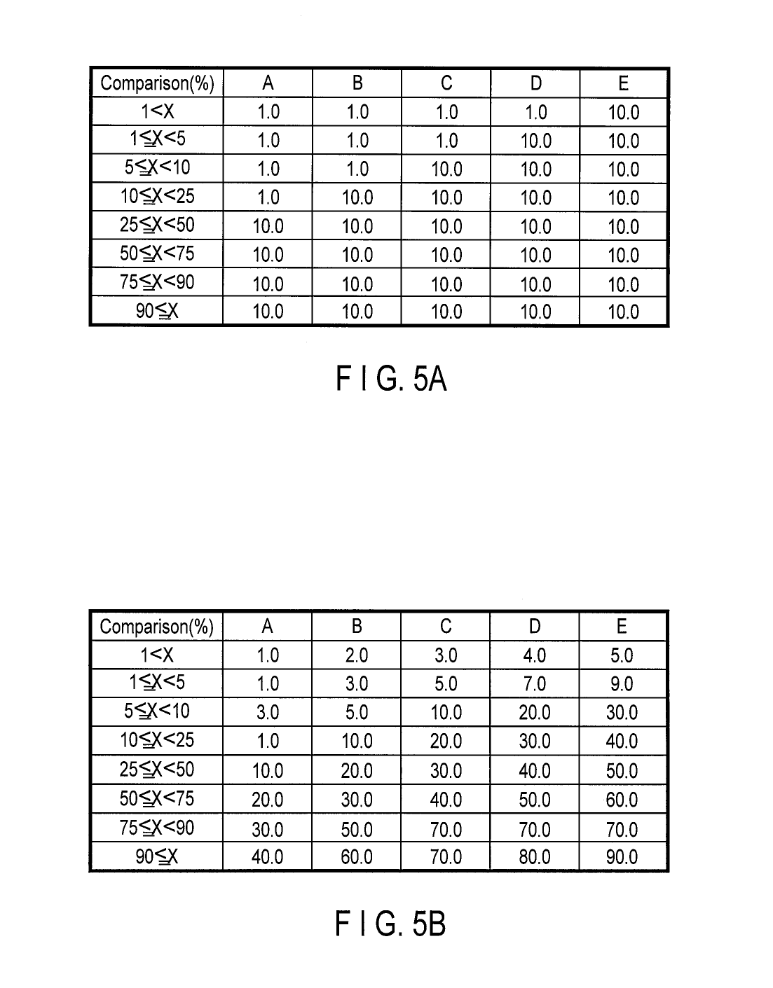

A value can be appropriately determined on the basis of, for example, a multiplying factor (factor of multiplication) based on the rules of classification [A]-[E] as shown below and the ratio (X) between the number of corresponding users (the number of television devices/the number of viewers) and the number of all users, as shown in FIG. 5A and FIG. 5B, etc.

[A] information on a recommendation program (“scene information”) is not used (is not accessed)

[B] information on a recommendation program (“scene information”) is only accessed

[C] a program is viewed (recorded) by using information on a recommendation program (“scene information”)

[D] a program recorded by using information on a recommendation program (“scene information”) is inhibited from being deleted (is protected <is set as an object to be saved for a long time>) and

[E] information in a program viewed (recorded) by using information on a recommendation program (“scene information”) is responded to (a site introduced in a program is browsed).

Thus, if a value (first value) of information supplied by the metadata supply source to the user is large as compared to a value (second value) of information supplied by the user to the metadata supply source, a “difference” between the values is supplied (paid) as a value from the user to the metadata supply source. As a matter of course, if a value (second value) of information supplied by the user to the metadata supply source is large as compared to a value (first value) of information supplied by the metadata supply source to the user, a “difference” between the values is supplied (paid) as a value from the metadata supply source to the user.

The examples shown in FIG. 5A and FIG. 5B are, for instance, an example of a value paid by the user to the metadata supply source, and show a multiplying factor determined by multiplying a unit price determined per metadata by the number of acquired metadata and further in accordance with the number (ratio) of users. For example, when determining a value with the metadata supply source, a multiplying factor can be determined as follows: [E]×10≦X25, etc.

Thus, a difference between values, i.e., an exchange value, is determined by comparing a value (second value) which is determined by the above multiplying factor and should be paid by the user and a value (first value) of information supplied by the data supply source.

The example shown in FIG. 5A is useful in determining a value by whether or not the user has done viewing (recording). That is, this is a method of determining a value in which a low multiplying factor is set for a popular program which will be viewed (recorded) by many users and instead a value occurs even if the number of users is small.

The example shown in FIG. 5B is an example in which a value received by the metadata supply source increases in a case in which the user views (records), for example, a program on travel, etc., and consequently may make a reservation (the classification of rule [E] can be applied).

A method of determining a value may be set per program or may be set in units of the number of users. For example, if the number of users is used as a unit, a value can occur only if a certain number of users use metadata. In addition, by the classification of rule [E], a value can occur if the contents introduced in a program receive a high response.

As the above-described rules of classification, for example, various conditions as shown below can be set a multiplying factor in accordance with the degree of interest in a program:
[a] increasing a multiplying factor for a positive reservation, in a recording reservation by automatic recording recommendation and a recording reservation (positive reservation) directly set by the user;
[b] increasing a multiplying factor for on-air viewing, in reproduction of a recorded program and direct viewing (on-air viewing) of a program being broadcast;
[b′] increasing a multiplying factor for a case of reproducing a recorded program, in reproduction of a recorded program and direct viewing (on-air viewing) of a program being broadcast;
[c] increasing a multiplying factor for a case of repeated viewing such as cutting out and saving by editing, or reproducing repeatedly, a part of a time period of a recorded program;
[d] a recorded program is time-shift reproduced and deleted or [d′] a recorded program is reproduced using a scene jump, or the like.

The calculation methods shown in FIG. 5A and FIG. 5B are held by the reference table 110, which the data controller 111 refers to, but can be updated (rewritten/changed) with arbitrary timing.

Thus, by adopting the embodiment, between the user and the data supply source, reception of values (or calculation of a value) for both of information supplied by the user and information received by the user from the data supply source can be easily and clearly achieved.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A value exchange method for use in a data management device configured to connect with a data supply source via a network comprising:
calculating with a processor a first value corresponding to first information received from the data supply source comprising metadata extracted with a specific condition with respect to a first video program and a second value corresponding to second information supplied to the data supply source comprising history information associated with a result of viewing or recording of a second video program identified by the metadata based on a first value determination condition; and
determining a difference between the first value and the second value as an exchange value to be stored in storage.

2. The value exchange method of claim 1, wherein the history information relates to a reproduction method of the second video program, or to deletion or non-deletion of the second video program.

3. An electronic device comprising:
a processor configured to calculate a first value corresponding to information received from a data supply source comprising metadata extracted with a specific condition with respect to a first video program and a second value corresponding to information supplied to the data supply source comprising history information associated with a result of viewing or recording of a second video program identified by the metadata based on a prescribed value determination condition, and to determine a difference between the first value and the second value as an exchange value to be stored in storage.
